(19) United States
(12) Patent Application Publication
(10) Pub. No.: US 2026/0241525 A1
(43) Pub. Date: Aug. 20, 2026

(54) DRIVING TOOL

(71) Applicant: MAX CO., LTD., Tokyo (JP)

(72) Inventors: Tatsuya Moteki, Tokyo (JP); Kousuke MORIWAKI, Tokyo (JP)

(21) Appl. No.: 19/542,446

(22) Filed: Feb. 17, 2026

(30) Foreign Application Priority Data
Feb. 17, 2025 (JP) 2025-023146

(51) Int. Cl. B25C 1/00

(52) U.S. Cl. CPC B25C 1/008

(57) ABSTRACT

A driving tool includes: a nose portion having an injection passage of a fastener; a drive mechanism configured to drive the fastener supplied to the injection passage; a trigger portion configured to actuate the drive mechanism; a movable member that is provided movably to take a first position where an operation of the trigger portion is enabled, and a second position where the operation of the trigger portion is disabled; and a contact arm that is configured to move by being pressed against a workpiece. The contact arm includes a first arm engageable with the movable member, a second arm that is configured to abut against the workpiece, and a rotating portion. The second arm is configured to be movable relative to the first arm by rotating the rotating portion. Rotation of the rotating portion is restricted by a magnetic force.

### CROSS-REFERENCE TO RELATED APPLICATIONS

This application is based on and claims priority under 35 USC §119 from Japanese Patent Application No. 2025-023146 filed on February 17, 2025, the contents of which are incorporated herein by reference.

### TECHNICAL FIELD

The present disclosure relates to a driving tool that drives a fastener. In particular, the present disclosure relates to a driving tool that is provided with a contact arm as a safety device and that can adjust the driving depth of a fastener by extending and retracting the contact arm.

### BACKGROUND

As this type of driving tool, one provided with a contact arm as a safety device is known. A tip end of the contact arm protrudes from a tip end of a nose portion that drives the fastener, and is operable to be pushed in a direction opposite to a driving direction of the fastener by being pressed against a workpiece. A base end portion of the contact arm extends to a vicinity of a trigger of the driving tool and is engageable with a lever, a switch, or the like that switches between enabling and disabling a trigger operation. In a sign-OFF state before the contact arm is pushed, the trigger operation is disabled, and the driving operation is not executed even when the user operates the trigger. On the other hand, in a sign-ON state where the contact arm is pushed to a predetermined position, the trigger operation is enabled, and when the operator operates the trigger, the driving operation is executed.

Also known is a driving tool in which the contact arm is configured with two or more components, and the contact arm is made extendable and retractable. By adjusting a length of the contact arm, the user can change a distance between the tip end of the nose portion and the workpiece in the sign-ON state, thereby enabling adjustment of the driving depth of the fastener.

An adjustment mechanism of the contact arm is generally provided with a threaded portion on a contact bolt that is a part of the contact arm, and including a dial that rotates the contact bolt. By rotationally operating the dial, the user causes the contact arm to extend and retract by a screw action of the contact bolt.

In such an adjustment mechanism of the contact arm, it is known to be provided with means for locking the contact arm at an adjusted position. For example, JP2002-346947A discloses a configuration in which a steel ball is accommodated in a hole formed on a lower surface of the dial and biased by a spring, and is engaged with a recess portion formed on a facing surface of the dial, thereby preventing unintentional rotation of the dial and providing a clicking sensation during the rotational operation.

However, in the configuration using the steel ball described above, dimensional control between the dial and the recess portion is strict, and when the dimensions do not match, there is a risk that the steel ball may fall out. In addition, the spring must be compressed while assembling the steel ball, resulting in poor assemblability during manufacturing.

Accordingly, the present disclosure relates to means for temporarily holding the contact arm at an adjusted position, and has as an object to provide a driving tool in which assembly during manufacturing and dimensional control are easy, and operational load can be stabilized.

### SUMMARY

A driving tool for driving a fastener, includes: a nose portion having an injection passage of the fastener; a drive mechanism configured to drive the fastener supplied to the injection passage; a trigger portion configured to actuate the drive mechanism; a movable member that is provided movably to take a first position where an operation of the trigger portion is enabled, and a second position where the operation of the trigger portion is disabled; and a contact arm that is provided slidably with respect to the nose portion and that is configured to move by being pressed against a workpiece. The contact arm includes a first arm engageable with the movable member, a second arm that extends from the first arm in a driving direction and that is configured to abut against the workpiece, and a rotating portion configured to be rotatable. The second arm is configured to be movable relative to the first arm by rotating the rotating portion. Rotation of the rotating portion is restricted by a magnetic force.

### BRIEF DESCRIPTION OF DRAWINGS

FIG. 1 is an enlarged view of the vicinity of a nose portion of a driving tool.

FIG. 2 is a side view of a contact arm.

FIG. 3 is a sectional view taken along line A-A of FIG. 2.

FIG. 4A is a sectional view illustrating an internal structure of a rotating portion.

FIG. 4B is a schematic view illustrating a configuration of the vicinity of an opening edge of an accommodation portion, in which (a) is a view according to an embodiment, (b) is a view according to another embodiment 1, and (c) is a view according to another embodiment 2.

FIG. 5 is a longitudinal sectional view of the vicinity of the rotating portion (when the contact arm is shortened to the minimum).

FIG. 6 is a longitudinal sectional view of the vicinity of the rotating portion (when the contact arm is lengthened to the maximum).

FIG. 7 is a longitudinal sectional view of the vicinity of the rotating portion according to Modified Example 1.

FIG. 8 is a longitudinal sectional view of the vicinity of the rotating portion according to Modified Example 2.

FIG. 9 is a longitudinal sectional view of the vicinity of the rotating portion according to Modified Example 3.

FIG. 10 is a longitudinal sectional view of the vicinity of the rotating portion according to Modified Example 4.

FIG. 11 is a longitudinal sectional view of the vicinity of the rotating portion according to Modified Example 5.

FIG. 12 is a longitudinal sectional view of the vicinity of the rotating portion according to Modified Example 6 (when the contact arm is shortened to the minimum).

FIG. 13 is a longitudinal sectional view of the vicinity of the rotating portion according to Modified Example 6 (when the contact arm is lengthened to the maximum).

FIG. 14 is a longitudinal sectional view of the vicinity of the rotating portion according to Modified Example 7.

FIG. 15 is a sectional view of the vicinity of a trigger according to Modified Example 8.

### DESCRIPTION OF EMBODIMENTS

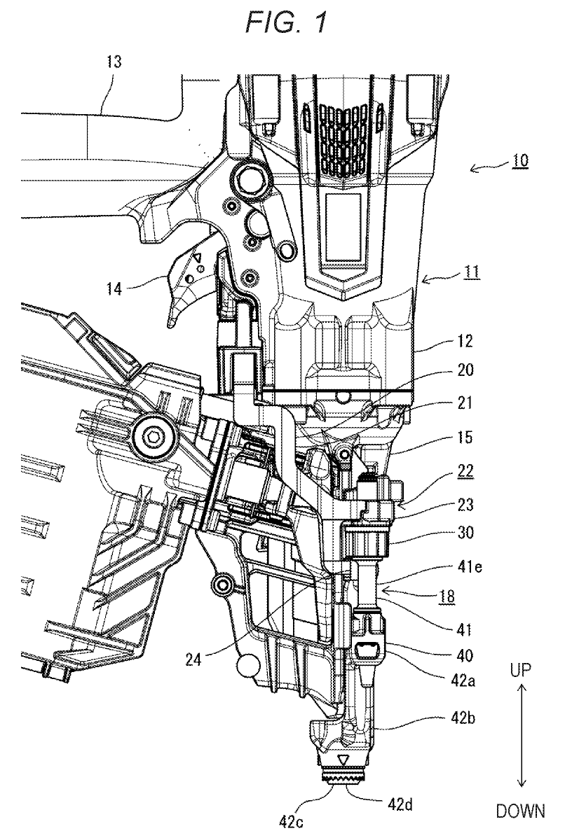

An embodiment of the present invention will be described with reference to the drawings. In the following description, the injection direction of a fastener is referred to as “downward” and the direction opposite to the downward direction is referred to as “upward” as illustrated in FIG. 1.

As illustrated in FIG. 1, a driving tool 10 according to the present embodiment has a tool main body 11 integrally including a body housing 12, a grip 13, and a nose portion 15. The body housing 12, the grip 13, and the nose portion 15 may be formed from separate members or may be formed from the same member.

The body housing 12 incorporates a drive mechanism for driving the fastener. The drive mechanism may have a known structure. For example, a drive mechanism that operates using compressed air, gas, electricity, or the like as a power source can be used.

The grip 13 is a rod-shaped part grasped by an operator when using the driving tool 10. The grip 13 is provided at the rear of the body housing 12 and extends in a direction substantially orthogonal to the body housing 12. A trigger 14 that can be operated by the operator is provided at the front end of the grip 13. When the trigger 14 is operated in the sign-ON state described below, the drive mechanism (such as a piston cylinder mechanism or a spring mechanism) incorporated in the body housing 12 is activated to drive the fastener.

The nose portion 15 is integrally provided below the body housing 12. A fastener injection passage (not illustrated) is formed inside the nose portion 15. An injection port 42d, which will be described later, is provided below the injection passage. When the drive mechanism is activated, the fastener waiting in the injection passage is injected from the injection port 42d.

A contact arm 18 is attached to the nose portion 15. The contact arm 18 forms a safety mechanism for preventing malfunction of the driving operation. The safety mechanism is a mechanism for controlling the fastener not to be driven when the nose portion 15 is not pressed against the workpiece. The contact arm 18 is provided to be slidable up and down relative to the nose portion 15. The contact arm 18 is constantly biased in the protruding direction (downward) by biasing means such as a spring (not illustrated), and the tip end thereof protrudes downward beyond the nose portion 15. The contact arm 18 can be moved upward against the biasing force of the biasing means by being pressed against the workpiece.

In a state where the contact arm 18 is not pressed against the workpiece, the contact arm 18 is biased downward and protrudes. This state is a sign-OFF state where the operation of the trigger 14 is disabled. Even when the trigger 14 is operated in the sign-OFF state, the fastener is not driven.

On the other hand, when the contact arm 18 is pressed against the workpiece and moves upward to a predetermined position, the state shifts to the sign-ON state where the operation of the trigger 14 is enabled. When the trigger 14 is operated in this sign-ON state, the fastener is driven.

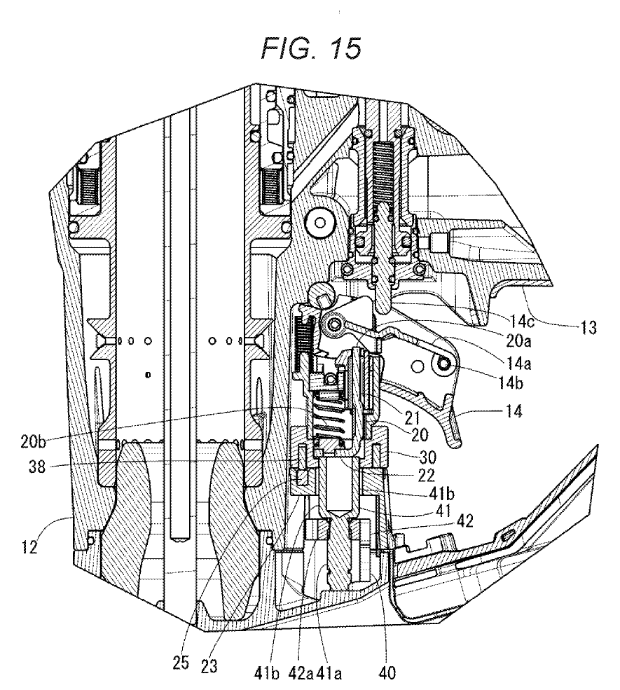

It should be noted that means for enabling or disabling the operation of the trigger 14 may be any known means. For example, as illustrated in FIG. 15, a contact lever 14a may be attached to the inside of the trigger 14 to be rotatable. The contact lever 14a is rotatable about a pivot point 14b provided inside the trigger 14, and is disposed at a position capable of pressing a switch, valve, or the like (the valve 14c in FIG. 15) for activating the drive mechanism. In the sign-ON state, the end portion of the contact lever 14a is held directly or indirectly by the contact arm 18. For example, a trigger engaging portion 20a formed at the upper end of the contact arm 18 engages with the lower surface of the contact lever 14a. When the trigger 14 is operated in this state, the contact lever 14a rotates in conjunction with the trigger 14 because the downward movement of the contact lever 14a is suppressed. When the contact lever 14a rotates, the valve 14c for activating the drive mechanism is pushed upward and activated, thereby operating the drive mechanism.

On the other hand, in the sign-OFF state, the contact lever 14a is not held directly or indirectly by the contact arm 18, and the end portion of the contact lever 14a is free. Therefore, even when the trigger 14 is operated, the contact lever 14a is not forced to rotate in conjunction with the trigger 14. When the contact lever 14a hits the valve 14c, the contact lever 14a moves downward, and thus the valve 14c is not pushed. In this manner, the operational load of the trigger 14 is not transmitted to the switch, valve, or the like for activating the drive mechanism, and thus the drive mechanism will not be activated even when the trigger 14 is operated.

In this manner, the contact lever 14a forms a movable member provided to be movable to be able to take a first position in which the operation of the trigger 14 is enabled and a second position in which the operation of the trigger 14 is disabled.

The safety mechanism using the contact lever 14a described above is merely an example. For example, a safety mechanism may be used in which the upper end of the contact arm 18 presses a microswitch to establish a sign-ON state. In such a configuration, the microswitch forms a movable member provided to be movable to be able to take the first position where the operation of the trigger 14 is enabled and the second position where the operation of the trigger 14 is disabled.

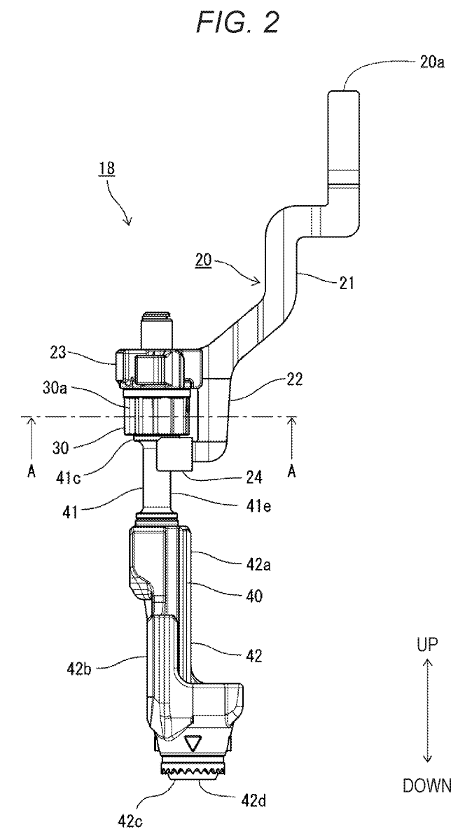

As illustrated in FIG. 2, the contact arm 18 according to the present embodiment is a unit made up of a plurality of components, and has a first arm 20, a second arm 40, and a rotating portion 30.

The first arm 20 is a member made of metal, which is connected to the tool main body 11. The first arm 20 has an extending portion 21 and a connecting portion 22.

The extending portion 21 extends up and down from the vicinity of the trigger 14 to the vicinity of the rotating portion 30. The extending portion 21 is a part provided along the side surface of the body housing 12 and the nose portion 15 in order to connect the connecting portion 22 (described later) to the vicinity of the trigger 14. The upper end of the extending portion 21 according to the present embodiment is configured to be engageable with the trigger portion (a unit including the trigger 14 and the contact lever 14a described above). For example, the extending portion 21 has a trigger engaging portion 20a that engages with the contact lever 14a described above. The trigger engaging portion 20a is provided at the upper end of the extending portion 21 and, when a sign-ON state is established, engages with the contact lever 14a to enable the driving operation of the fastener by the trigger 14. The trigger engaging portion 20a may be provided integrally with the extending portion 21 or may be provided as a separate member.

The connecting portion 22 is a part that is disposed to face the rotating portion 30, which will be described later. The connecting portion 22 according to the present embodiment is formed in a substantially U-shape in side view, and is provided in the vicinity of the lower end of the extending portion 21. The connecting portion 22 is connected to the rotating portion 30 and the second arm 40, which will be described later. As illustrated in FIG. 2, the connecting portion 22 in the present embodiment has a facing portion 23 facing one surface (upper surface 30e) of the rotating portion 30, and a support portion 24 facing the other surface (lower surface 30f) of the rotating portion 30. The facing portion 23 and the support portion 24 are disposed to face each other to sandwich the rotating portion 30 from above and below, and hold the rotating portion 30 not to fall in the up-down direction. It should be noted that the interval in the up-down direction between the facing portion 23 and the support portion 24 is set to be slightly larger than the height of the rotating portion 30 in the up-down direction. This play allows the rotating portion 30 to rotate smoothly.

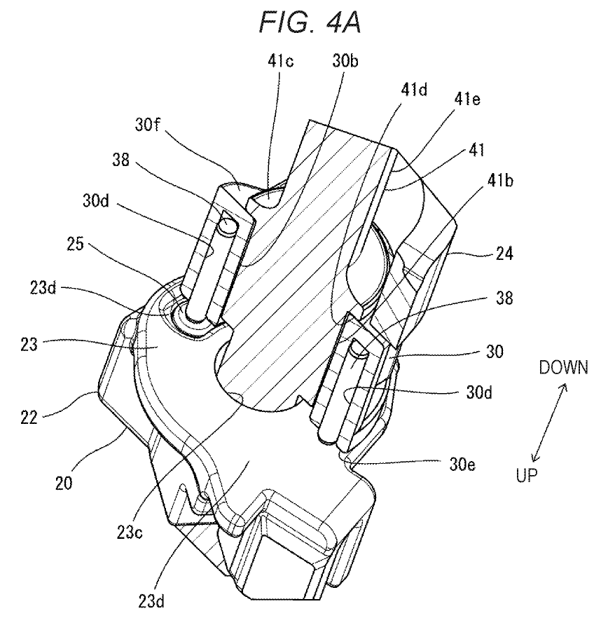

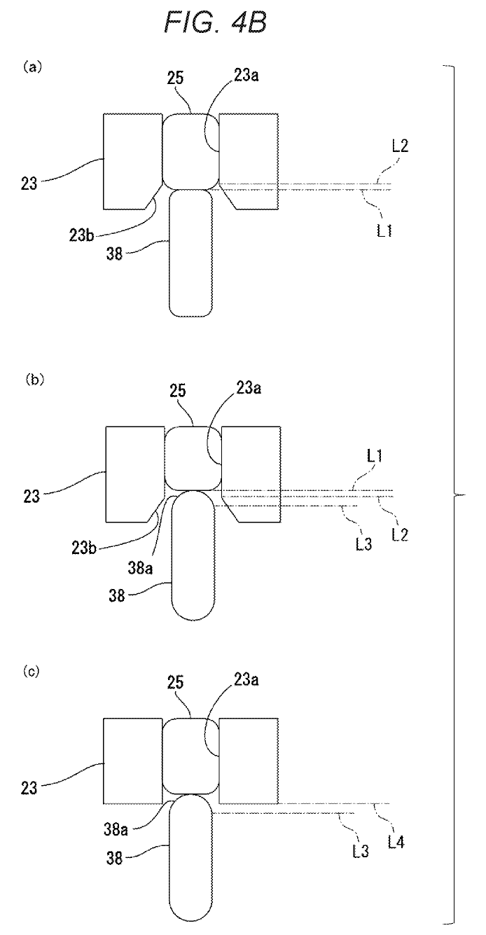

As illustrated in FIG. 4A, the facing portion 23 is disposed to face the rotating portion 30. Specifically, the lower surface (first seating surface 23d) of the facing portion 23 and the upper surface 30e of the rotating portion 30 are disposed facing each other in parallel.

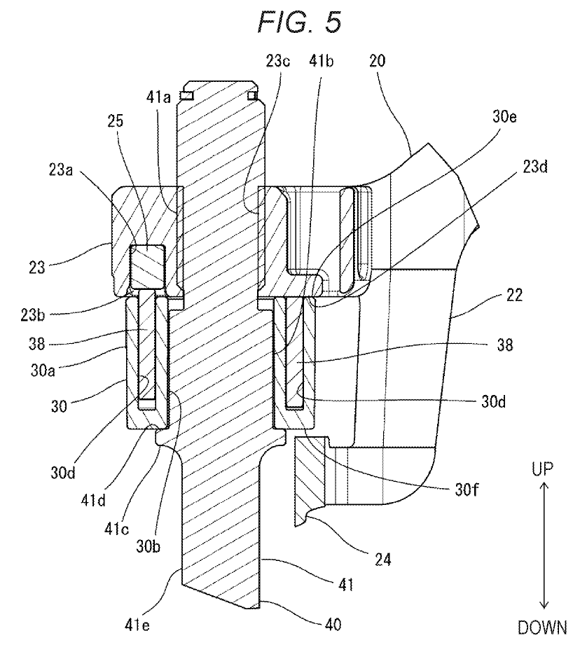

As illustrated in FIG. 5, the facing portion 23 is provided with a second restricting member 25 for temporarily holding the rotating portion 30. Specifically, an accommodation portion 23a is recessed in the first seating surface 23d facing the rotating portion 30, and the second restricting member 25 is accommodated in this accommodation portion 23a. The second restricting member 25 is fixed inside the accommodation portion 23a. The accommodation portion 23a is formed deeper than the length of the second restricting member 25, and the second restricting member 25 is fixed in a state of being completely buried inside the accommodation portion 23a. In other words, the end surface (lower surface) of the second restricting member 25 is disposed deeper than the first seating surface 23d.

The second restricting member 25 according to the present embodiment is made of a magnetic material (a ferromagnetic material such as a magnet). The second restricting member 25 is attracted to a first restricting member 38 (described later), thereby forming a temporary holding means for preventing the rotating portion 30 from rotating unintentionally.

An isolation portion 23b is provided on the opening edge of the above-mentioned accommodation portion 23a. The isolation portion 23b is for guiding the first restricting member 38 and the second restricting member 25 in a detachment direction when the rotating portion 30 rotates in a state where the first restricting member 38 and the second restricting member 25 are attracted to each other. The isolation portion 23b guides the first restricting member 38 in a direction away from the second restricting member 25 by converting the direction of the rotational movement of the rotating portion 30 and causing the rotational movement to act on the first restricting member 38. The isolation portion 23b also serves to restrict the rotation of the rotating portion 30. As illustrated in FIG. 4B(a), the isolation portion 23b according to the present embodiment is a tapered portion inclined in the rotational direction of the rotating portion 30 (the circumferential direction centered on the contact bolt 41 described later). As illustrated in FIGS. 4A, 4B and 5, the isolation portion 23b is formed in a cone shape to widen the opening edge of the accommodation portion 23a. The isolation portion 23b is formed as an inclined surface to connect the exposed surface (lower surface) of the second restricting member 25 and the opening edge of the accommodation portion 23a.

It should be noted that, as shown in FIG. 4B(a), the isolation portion 23b according to the present embodiment is configured such that a start position L2 of the inclined surface of the isolation portion 23b is set at a position deeper than a position L1 of the surface of the second restricting member 25 (the surface that is attracted to the first restricting member 38). By setting the isolation portion 23b at such a position, when the rotating portion 30 rotates in a state where the first restricting member 38 and the second restricting member 25 are attracted to each other, the first restricting member 38 does not catch on the opening edge of the accommodation portion 23a, and thus smooth rotation can be achieved.

However, the aspect of the isolation portion 23b is not limited to this, and as shown in FIG. 4B(b), the start position L2 of the inclined surface of the isolation portion 23b may be set at a position shallower than the position L1 of the surface of the second restricting member 25 (the surface that is attracted to the first restricting member 38). In this configuration, the tip end of the first restricting member 38 may be tapered or R-shaped to provide the first restricting member 38 with an isolation portion 38a. That is, the isolation portion 23b of the facing portion 23 and the isolation portion 38a of the first restricting member 38 may be provided.

As illustrated in FIG. 4B(b), it is desirable that a start position L3 of the isolation portion 38a of the first restricting member 38 be shallower than the start position L2 of the inclined surface of the isolation portion 23b in a state where the first restricting member 38 and the second restricting member 25 are attracted to each other. In other words, when the rotating portion 30 rotates in a state where the first restricting member 38 and the second restricting member 25 are attracted to each other, it is desirable that the isolation portion 38a (tapered portion or R-shaped portion) of the first restricting member 38 hit the corner of the start position L2 of the inclined surface of the isolation portion 23b.

Also, as shown in FIG. 4B(c), the isolation portion 23b may not be provided on the facing portion 23, and the isolation portion 38a may be provided only on the first restricting member 38. In this case, it is desirable that the start position L3 of the isolation portion 38a of the first restricting member 38 be shallower than a position L4 of the opening edge of the accommodation portion 23a (the isolation portion 38a is outside the accommodation portion 23a) in a state where the first restricting member 38 and the second restricting member 25 are attracted to each other. In other words, when the rotating portion 30 rotates in a state where the first restricting member 38 and the second restricting member 25 are attracted to each other, it is desirable that the isolation portion 38a (tapered or R-shaped) of the first restricting member 38 hit the corner portion of the opening edge of the accommodation portion 23a.

The accommodation portion 23a is provided at a position eccentric to the center of rotation of the rotating portion 30. In the present embodiment, there is one accommodation portion 23a, and there is also one second restricting member 25 accommodated in the accommodation portion 23a. However, a plurality of the accommodation portions 23a and the second restricting members 25 may be provided.

As illustrated in FIG. 5, a through-hole 23c is formed in the center of the facing portion 23. A female thread is formed on the inner peripheral surface of this through-hole 23c. A contact bolt 41, which will be described later, is inserted into this through-hole 23c. A male thread (a threaded portion 41a described later) that threadedly engages with the female thread of the through-hole 23c is formed on the contact bolt 41.

The second arm 40 is a member extending from the first arm 20 toward the tip end (downward). The second arm 40 extends up and down from the vicinity of the rotating portion 30 to the tip end of the nose portion 15. The tip end of the second arm 40 protrudes downward beyond the tip end of the nose portion 15 and can be pressed against the workpiece into which the fastener is to be driven. By pressing the tip end of the second arm 40 against the workpiece, the contact arm 18 is moved upward, and a sign-ON state is established.

The second arm 40 has the contact bolt 41 and a tip end arm 42. The contact bolt 41 and the tip end arm 42 are connected to each other to be movable (rotatable).

The contact bolt 41 is a member held by the connecting portion 22 of the first arm 20 to be rotatable and advanceable and retractable. As already described, the contact bolt 41 has the male thread that threadedly engages with the female thread formed in the through-hole 23c of the connecting portion 22, and is movable in the up-down direction by rotating. The contact bolt 41 is disposed such that the axis thereof is in the up-down direction.

As illustrated in FIG. 5, the contact bolt 41 includes the threaded portion 41a, a co-rotating portion 41b, a flange portion 41c, and a connecting shaft portion 41e.

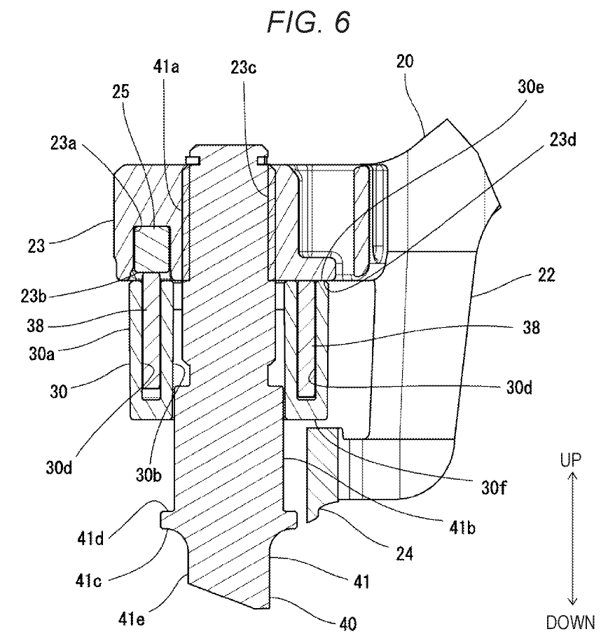

The threaded portion 41a is a part that threadedly engages with the female thread formed in the through-hole 23c of the connecting portion 22. The threaded portion 41a is provided in the vicinity of the upper end of the contact bolt 41, and has the male thread formed on the outer periphery. When the contact bolt 41 rotates, the contact bolt 41 moves up and down due to the screw action of the threaded portion 41a. Specifically, the contact bolt 41 is movable between a top dead center position illustrated in FIG. 5 and a bottom dead center position illustrated in FIG. 6.

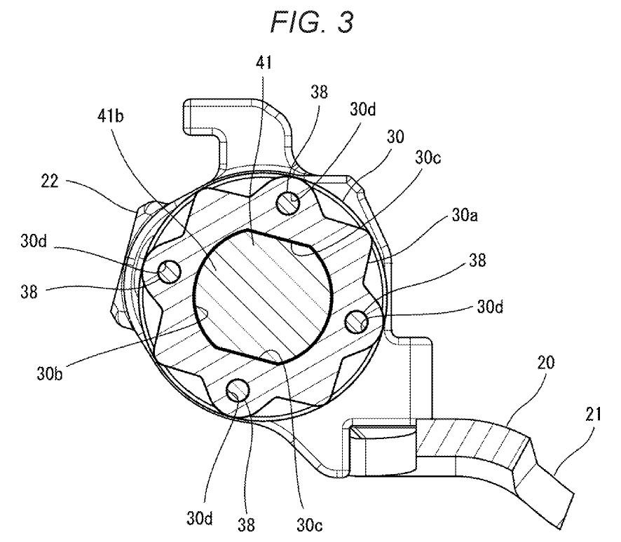

The co-rotating portion 41b is a part to which the rotating portion 30, which will be described later, is attached. In the present embodiment, the co-rotating portion 41b is disposed below and continuing from the threaded portion 41a, and is formed with a larger diameter than the threaded portion 41a. As illustrated in FIG. 3, the co-rotating portion 41b has a non-circular cross section, and rotates integrally with the rotating portion 30 by engaging with an insertion hole 30b of the rotating portion 30. The outer circumferential cross section of the co-rotating portion 41b according to the present embodiment has substantially the same shape as the inner circumferential cross section of the insertion hole 30b, thereby suppressing rattle. The co-rotating portion 41b and the rotating portion 30 engage with each other to be movable in the up-down direction. Therefore, the contact bolt 41 and the rotating portion 30 rotate integrally, but are also capable of moving up and down relative to each other.

The flange portion 41c is a part disposed below and continuing from the co-rotating portion 41b, and is formed with a larger diameter than the co-rotating portion 41b. As illustrated in FIG. 5, the upper surface of the flange portion 41c is a second seating surface 41d that can come into contact with the lower surface 30f of the rotating portion 30. The second seating surface 41d forms a surface perpendicular to the axial direction (up-down direction) of the contact bolt 41. The second seating surface 41d is formed as a flat surface to be in surface contact with the lower surface 30f of the rotating portion 30.

The connecting shaft portion 41e is a part that extends downward for attaching the tip end arm 42. The connecting shaft portion 41e is provided below the flange portion 41c. The connecting shaft portion 41e is rotatably connected to the tip end arm 42 in the vicinity of the lower end portion thereof.

The tip end arm 42 is a member that protrudes from the tip end of the nose portion 15 to abut against the workpiece. As illustrated in FIG. 2, the tip end arm 42 includes an attaching portion 42a, a hanging portion 42b, and a abutting portion 42c.

The attaching portion 42a is a part for attaching the contact bolt 41. The attaching portion 42a is formed in a cylindrical shape and rotatably holds the vicinity of the lower end portion of the contact bolt 41 (connecting shaft portion 41e). As a result, it is configured that even when the contact bolt 41 rotates, the tip end arm 42 does not rotate.

The hanging portion 42b is a part that extends downward from the attaching portion 42a. The hanging portion 42b slidably engages with the nose portion 15. This engagement guides the tip end arm 42 to be slid up and down along the nose portion 15.

The abutting portion 42c is a part that is provided at the tip end of the hanging portion 42b and abuts against the workpiece. The abutting portion 42c according to the present embodiment forms an injection passage of the fastener, and has the injection port 42d of the fastener formed at the tip end. The injection passage of the fastener is formed in a cylindrical shape with a constant inner diameter to stabilize the driving posture of the fastener, and the injection port 42d is the opening portion of this injection passage.

The rotating portion 30 is a member rotatably provided at a position where the first arm 20 and the second arm 40 are connected. In the present embodiment, the rotating portion 30 is made of a non-magnetic material (for example, synthetic resin). The rotating portion 30 is provided to be operable by the user, and can be formed as, for example, a dial that can be operated from the outside. By rotating this rotating portion 30, the overall length of the contact arm 18 can be extended or contracted. The rotating portion 30 is disposed such that the rotation axis is in the up-down direction. The rotation axis of the rotating portion 30 is aligned with the rotation axis of the contact bolt 41.

The rotating portion 30 according to the present embodiment is formed in a substantially cylindrical shape. An outer periphery portion 30a of the rotating portion 30 is exposed to be operable, and the user can rotate the outer periphery portion 30a by hand. As illustrated in FIG. 3, the outer periphery portion 30a of the rotating portion 30 is formed with irregularities in the circumferential direction to facilitate the operation.

The rotating portion 30 is also formed with the insertion hole 30b that penetrates in the axial direction (up-down direction). The co-rotating portion 41b of the contact bolt 41 is inserted into this insertion hole 30b to be movable up and down. As illustrated in FIG. 3, the insertion hole 30b has a non-circular cross section and is formed to engage with the co-rotating portion 41b. The insertion hole 30b according to the present embodiment includes an engaging portion 30c formed linearly in plan view, and by this engaging portion 30c engaging with the outer peripheral surface of the co-rotating portion 41b, the rotating portion 30 and the co-rotating portion 41b are made to rotate integrally. Therefore, when the rotating portion 30 is rotationally operated, the contact bolt 41 also rotates in conjunction with this.

The rotating portion 30 has an upper surface 30e facing the facing portion 23 of the first arm 20, and a lower surface 30f facing the support portion 24 of the first arm 20. The rotating portion 30 is restricted from moving up and down by the facing portion 23 and the support portion 24 of the first arm 20, and cannot move up and down except with a small clearance. However, it is possible to rotate the contact bolt 41 as the rotation axis.

As illustrated in FIGS. 3 to 5, the rotating portion 30 is provided with the first restricting member 38. In the present embodiment, the first restricting member 38 is accommodated in a holding hole 30d formed to open on the upper surface 30e of the rotating portion 30. A plurality of first restricting members 38 are arranged at regular intervals in the circumferential direction of the rotating portion 30 (four first restricting members 38 are arranged in the example of FIG. 3). The number of first restricting members 38 can be set as desired. For example, the number of first restricting members 38 may be one or may be a plurality. Increasing the number of first restricting members 38 increases the number of positioning positions, making it possible to provide a mechanism capable of finely setting the depth adjustment.

The holding hole 30d is provided at a position eccentric to the center of rotation of the rotating portion 30. The degree of eccentricity of the holding hole 30d (first restricting member 38) is set to be equal to the degree of eccentricity of the accommodation portion 23a (second restricting member 25). That is, when the rotating portion 30 rotates to a predetermined position, the first restricting member 38 accommodated in the holding hole 30d and the second restricting member 25 accommodated in the accommodation portion 23a face each other.

The first restricting member 38 is attracted to the second restricting member 25 by magnetic force. When the second restricting member 25 is a magnet, the first restricting member 38 may be a magnet or a ferromagnetic material such as metal. Furthermore, when the first restricting member 38 is a magnet, the second restricting member 25 may be a magnet or a ferromagnetic material such as metal.

The first restricting member 38 is provided to restrict the rotation of the rotating portion 30 by magnetic force. That is, as illustrated in FIG. 5, when the rotating portion 30 rotates to a predetermined angle, the first restricting member 38 and the second restricting member 25 face each other and are attracted to each other. As a result, the rotating portion 30 is temporarily held at that position, and the rotating portion 30 will not rotate unless a certain force acts to rotate the rotating portion 30.

It is also possible to assist the rotation of the rotating portion 30 by using the first restricting member 38 and the second restricting member 25. That is, the first restricting member 38 and the second restricting member 25 may attract each other to assist the rotational operation of the rotating portion 30. In the present embodiment, the first restricting members 38 are arranged at 90-degree intervals in the circumferential direction of the rotating portion 30, and thus, even when the rotating portion 30 is appropriately rotationally operated, the rotating portion 30 will stop exactly at every 90 degrees.

As illustrated in FIG. 4A, the first restricting member 38 according to the present embodiment is a pin inserted into the holding hole 30d of the rotating portion 30. The first restricting member 38 is accommodated in the holding hole 30d to be movable up and down. In other words, the holding hole 30d of the rotating portion 30 functions as a guide portion that guides the first restricting member 38 (pin) to be movable up and down. Therefore, as illustrated in FIG. 5, when the first restricting member 38 and the second restricting member 25 face each other, the first restricting member 38 moves along the holding hole 30d and is attracted to the second restricting member 25. With this configuration, when the rotating portion 30 is rotated and the first restricting member 38 and the second restricting member 25 are attached to each other, the user can feel a clicking sensation. The movement direction of the first restricting member 38 is a direction perpendicular to the attraction surfaces of the first restricting member 38 and the second restricting member 25. In the present embodiment, the first restricting member 38 is guided in its movement by the holding hole 30d (guide portion). However, the invention is not limited thereto, and in a case where the second restricting member 25 is made movable within the accommodation portion 23a, the movement of the second restricting member 25 may be guided by the accommodation portion 23a (guide portion).

The first restricting member 38 is capable of protruding from and retracting into the holding hole 30d. As illustrated in FIG. 5, in the present embodiment, when the first restricting member 38 and the second restricting member 25 are attracted to each other, the tip end of the first restricting member 38 enters the inside of the accommodation portion 23a. Therefore, the temporary fixation of the rotating portion 30 is stabilized, and the effect of preventing the rotating portion 30 from rotating unintentionally is improved.

The opening edge of the accommodation portion 23a into which the tip end of the first restricting member 38 enters is provided with the isolation portion 23b as already described. The isolation portion 23b according to the present embodiment is a tapered portion that is inclined in the rotational direction of the rotating portion 30. That is, no matter in which direction the rotating portion 30 rotates, the tip end of the first restricting member 38 hits the tapered portion. Therefore, when the rotating portion 30 rotates in a state where the first restricting member 38 and the second restricting member 25 are attracted to each other, the tip end of the first restricting member 38 is guided downward along the isolation portion 23b (tapered portion) and is pulled away from the second restricting member 25. As a result, the temporary fixing of the rotating portion 30 can be released smoothly. As illustrated in the variation in FIG. 4B, the inclination start position of the isolation portion 23b can be set as desired, and the taper angle of the isolation portion 23b can also be set as desired. By setting the isolation portion 23b in this manner, it is possible to set the load that restricts the rotation of the rotating portion 30. For example, the closer the taper angle of the isolation portion 23b is to a perpendicular angle, the higher the load that restricts the rotation of the rotating portion 30 becomes. Therefore, the load that restricts the rotation of the rotating portion 30 can be set according to the characteristics of the driving tool 10, such as the application and strength of the impact when driving.

In the present embodiment, it is described that the first restricting member 38 is movable, but the second restricting member 25 may be configured to be movable. In this case, when the first restricting member 38 and the second restricting member 25 are attracted to each other, the tip end of the second restricting member 25 may enter the inside of the holding hole 30d of the rotating portion 30. In addition, the isolation portion (means for guiding the first restricting member 38 and the second restricting member 25 in the detachment direction when the rotating portion 30 rotates in a state where the first restricting member 38 and the second restricting member 25 are attracted) may be provided on the opening edge of the holding hole 30d.

Furthermore, in the present embodiment, a tapered portion is used as the isolation portion 23b. However, the invention is not limited thereto, and the first restricting member 38 and the second restricting member 25 may be guided in the detachment direction by another shape (such as a protrusion).

Furthermore, although the rotating portion 30 according to the present embodiment is a dial that can be operated by the user, the configuration of the rotating portion is not limited to this. For example, instead of the user directly operating the rotating portion, the user may operate a separate operating portion from the rotating portion. In this case, when the user operates the operating portion, the rotating portion may rotate in conjunction with the operation. Also, the rotating portion may be operated with a tool such as a Phillips screwdriver.

As described above, according to the present embodiment, the rotation of the rotating portion 30 is restricted by magnetic force, and thus there is no need to use steel balls as in the related art. Therefore, since small components are not used and it is not necessary to compress a spring for assembly, assemblability during manufacturing is good. Further, strict dimensional control is not required, and stable operational load can be achieved even with rough dimensional control.

In addition, in the conventional adjustment mechanism of the contact arm, there is also a tool equipped with a mechanism that restricts the rotation of the dial by inserting a cantilever-shaped claw portion into a groove on the outer periphery of the dial. A configuration in which the position of the dial is temporarily held by engagement of the claw portion is easier to assemble than a configuration using a steel ball. However, when there are problems in machining accuracy due to dimensional tolerances or deformation during molding, the strength of engagement between the claw portion and the dial changes, resulting in problems such as insufficient temporary holding or, conversely, temporary holding being too strong to rotate the dial. Furthermore, the strength of engagement of the claw portions changes due to deterioration over time, which causes a problem that the operational load changes over many years of use.

In this regard, with the configuration of the present embodiment, the operational load is less likely to change due to deterioration over time, and the operational load can be stabilized.

Furthermore, the first restricting member 38 and the second restricting member 25 generate a magnetic field in the direction of the rotation axis of the rotating portion 30 (up-down direction). With this configuration, there is no need to place the first restricting member 38 and the second restricting member 25 on the outer periphery portion 30a of the rotating portion 30, and thus the outer periphery portion 30a of the rotating portion 30 can be exposed to be operable, making it easier to operate the rotating portion 30 directly.

In the present embodiment, when the rotating portion 30 is rotated in a direction that shortens the contact arm 18, the rotating portion 30 is sandwiched between the first arm 20 and the second arm 40, thereby restricting the movement of the contact arm 18 in the shortening direction. Specifically, as illustrated in FIG. 5, when the contact arm 18 is at its shortest length (in other words, when the contact bolt 41 is at the top dead center position), the upper surface 30e of the rotating portion 30 abuts against the first seating surface 23d of the first arm 20, and the lower surface 30f of the rotating portion 30 abuts against the second seating surface 41d of the second arm 40. That is, the rotating portion 30 (dial) itself acts as a member that restricts the movement, and the torque of the rotating portion 30 is distributed and received by the two seating surfaces (the first seating surface 23d and the second seating surface 41d). With this configuration, torque can be received over a wide area, and excessive rotation of the rotating portion 30 can be suppressed. By suppressing excessive rotation of the rotating portion 30, it is possible to suppress the phenomenon of the screw seizing (the phenomenon in which the screw is tightened and cannot be rotated in the opposite direction).

Conventionally, there is only one seating surface, and a buffer member such as an O-ring is disposed on this one seating surface to prevent “galling”. However, with this conventional structure, when oil adheres to the O-ring, friction in the radial direction is reduced and the axial force increases, and when the oil dries, friction increases when returning the O-ring, increasing the return torque and making it impossible to loosen the O-ring.

In this regard, according to the present embodiment, the seating surface is increased, and thus torque can be received over a wide surface without increasing the diameter (contact area) of the rotating portion 30. In other words, galling can be effectively prevented without increasing the size of the components. Furthermore, since galling can be prevented without using an O-ring, the number of components can be reduced.

Although the first arm 20 of the present embodiment has been described as being entirely made of metal, the present invention is not limited to this and only a part of the first arm 20 may be made of metal. For example, only the connecting portion 22 may be made of metal.

### Modified Example 1

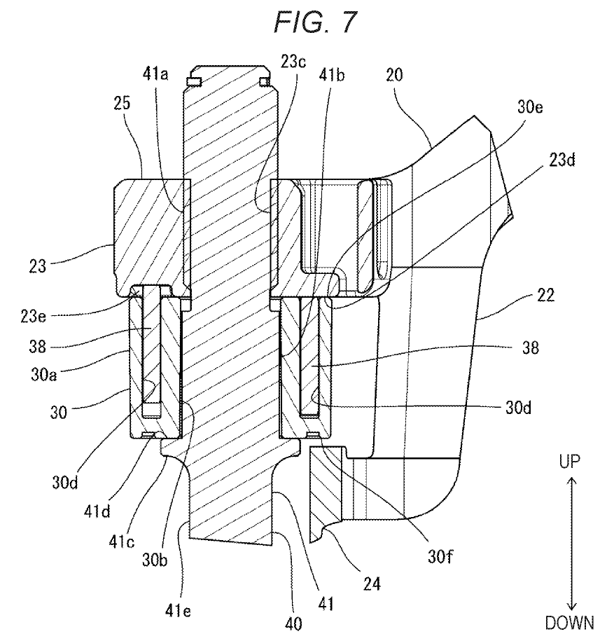

In the above embodiment, the second restricting member 25 is accommodated in the accommodation portion 23a of the facing portion 23. However, instead of this, all or a part of the facing portion 23 may be used as the second restricting member 25. For example, as illustrated in FIG. 7, the facing portion 23 may be made of a magnetic material such as metal, and the facing portion 23 itself may serve as the second restricting member 25. The first restricting member 38 may also be formed of a magnet.

In this case, a recess portion 23e may be provided in the first seating surface 23d, and the first restricting member 38 may engage with this recess portion 23e. When the first restricting member 38 is formed of a magnet, the first restricting member 38 is always attracted to the first seating surface 23d, and thus the rotation of the rotating portion 30 can be restricted. Furthermore, the first restricting member 38 enters and engages with the recess portion 23e by its own magnetic force, and the resistance with the inner peripheral surface of the recess portion 23e strengthens the restriction of rotation.

### Modified Example 2

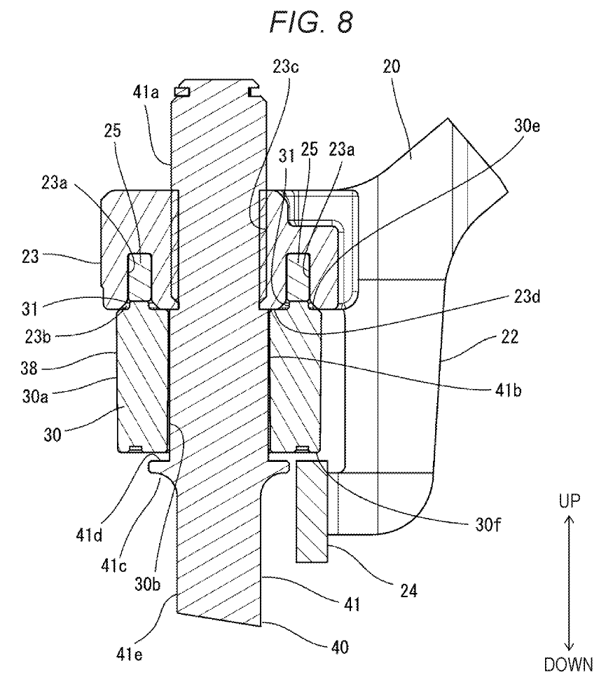

In the above embodiment, the first restricting member 38 is accommodated in the holding hole 30d of the rotating portion 30, but instead, all or a part of the rotating portion 30 may be used as the first restricting member 38. For example, as illustrated in FIG. 8, the rotating portion 30 may be made of a magnetic material such as metal, and the rotating portion 30 itself may serve as the first restricting member 38. The second restricting member 25 may also be formed of a magnet.

In this case, a convex portion 31 may be provided on the upper surface 30e of the rotating portion 30, and this convex portion 31 may engage with the accommodation portion 23a of the facing portion 23. The difference between the interval in the up-down direction between the facing portion 23 and the support portion 24 and the height of the rotating portion 30 in the up-down direction may be set to be equal to or greater than the height of the convex portion 31. By setting the clearance in the up-down direction between the rotating portion 30 and the connecting portion 22 to be equal to or greater than the height of the convex portion 31, the rotating portion 30 can rotate over the height of the convex portion 31. Furthermore, since the rotating portion 30 itself is attracted to the second restricting member 25, there is no need to configure the first restricting member 38 as a separate member, and the number of components can be reduced.

### Modified Example 3

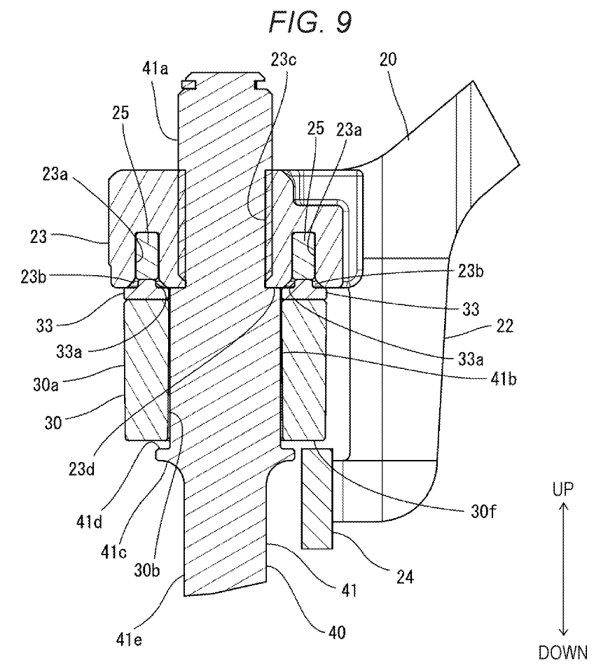

In the above embodiment, the first restricting member 38 is accommodated in the holding hole 30d of the rotating portion 30. However, instead, a disc-shaped attracting portion 33 may be disposed on the upper portion of the rotating portion 30, and all or a part of the attracting portion 33 may be used as the first restricting member 38. For example, as illustrated in FIG. 9, the attracting portion 33 may be fixed or disposed to rotate together on the upper portion of the rotating portion 30 made of synthetic resin. The attracting portion 33 may be made of a magnetic material such as metal. The second restricting member 25 may also be formed of a magnet.

In this case, the convex portion 33a may be provided on the surface of the attracting portion 33 such that the convex portion 33a engages with the accommodation portion 23a of the facing portion 23.

According to this modified example, a magnetic material such as a metal is used only in a part of the rotating portion 30, and thus the weight of the rotating portion 30 can be reduced compared to Modified Example 2.

### Modified Example 4

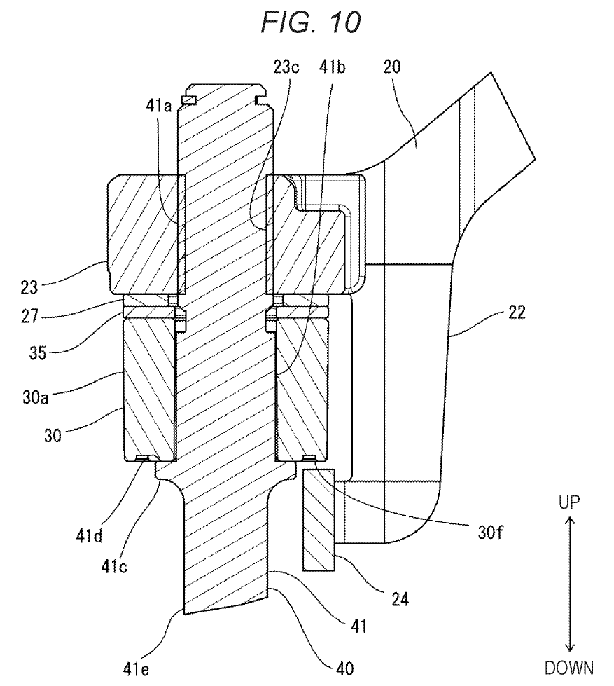

As illustrated in FIG. 10, a first plate 35 may be fixed to the rotating portion 30 to serve as a first restricting member, and a second plate 27 may be fixed to the facing portion 23 to serve as a second restricting member. The first plate 35 and the second plate 27 may be disk-shaped plates arranged to face each other.

At least one of the first plate 35 and the second plate 27 may be formed of a magnet. Furthermore, the first plate 35 or the second plate 27 that is not made of a magnet may be made of a magnetic material such as metal.

In this manner, when the first restricting member and the second restricting members, which have no irregularities, are attracted to each other by their surfaces, a stepless adjustment mechanism can be provided. Furthermore, since the surface on which the magnetic force acts can be made wide, the positioning effect is high even without providing an engagement structure with irregularities.

### Modified Example 5

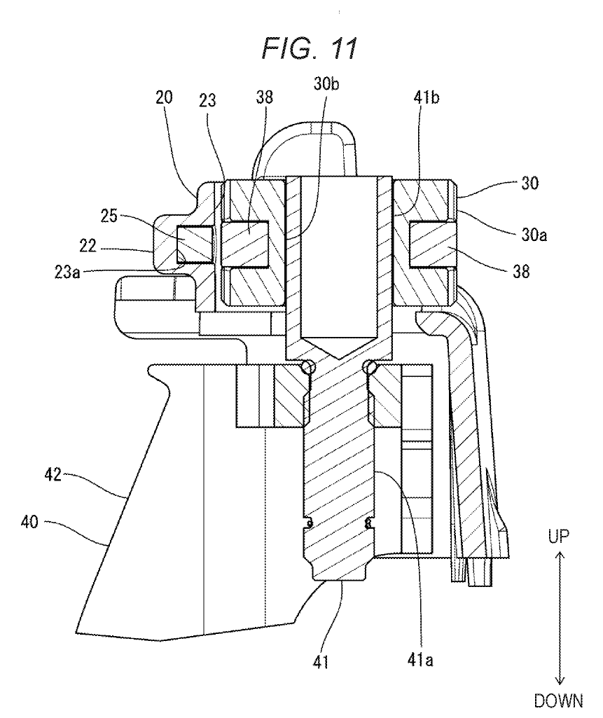

As illustrated in FIG. 11, the first restricting member 38 and the second restricting member 25 may generate a magnetic field in a direction orthogonal to a direction of the rotation axis of the rotating portion 30. For example, the first restricting member 38 may be provided to be exposed in the outer circumferential direction of the rotating portion 30. One or more first restricting members 38 are arranged at regular intervals in the circumferential direction of the rotating portion 30. The facing portion 23 of the first arm 20 may be provided at a position that can face the outer periphery portion 30a of the rotating portion 30, and the second restricting member 25 may be provided on this facing portion 23.

At least one of the first restricting member 38 and the second restricting member 25 may be formed of a magnet. Furthermore, the first restricting member 38 or the second restricting member 25 that is not made of a magnet may be made of a magnetic material such as metal.

In this modified example, the facing portion 23 is not provided in the up-down direction, and thus the contact arm 18 can be shortened, and the function of the present invention can be achieved even with a smaller driving tool 10.

### Modified Example 6

In the above embodiment, the upper surface 30e of the rotating portion 30 abuts against the first seating surface 23d of the first arm 20, and the lower surface 30f of the rotating portion 30 abuts against the second seating surface 41d of the second arm 40, but the torque of the rotating portion 30 may be distributed and received in other ways.

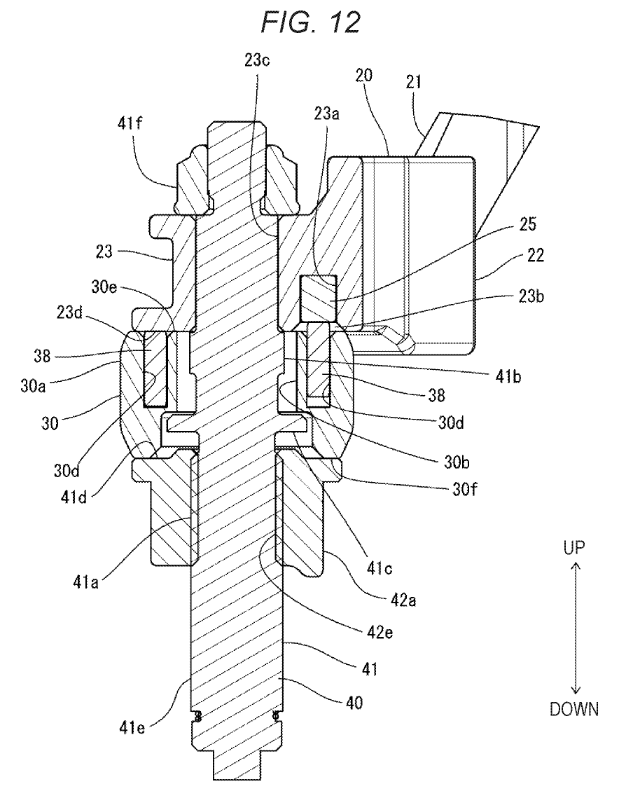

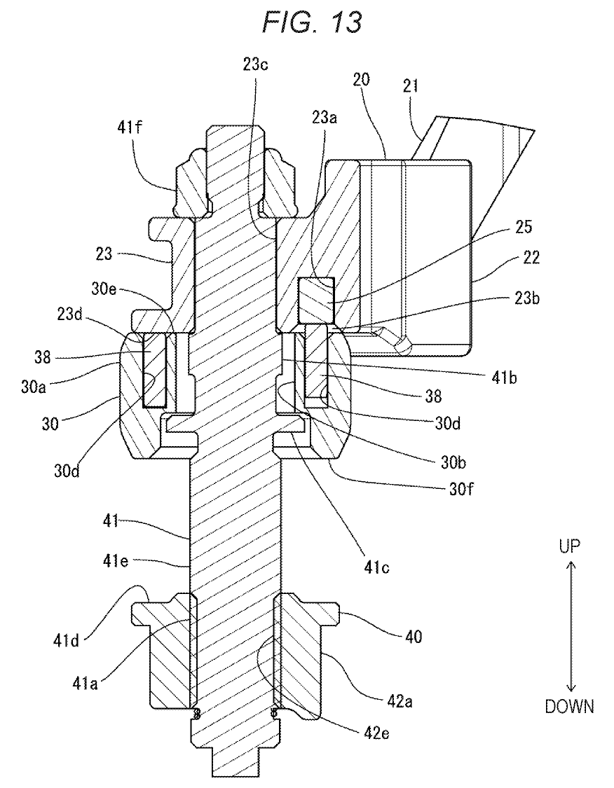

For example, in the manner illustrated in FIGS. 12 and 13, when the rotating portion 30 is rotated in a direction that shortens the contact arm 18, the rotating portion 30 may be sandwiched between the first arm 20 and the second arm 40, thereby restricting the movement of the contact arm 18 in the shortening direction.

In this modified example, as illustrated in FIGS. 12 and 13, when the rotating portion 30 rotates, it is configured such that the second arm 40 moves up and down instead of the contact bolt 41 moving up and down.

The first arm 20 rotatably supports the contact bolt 41 via the through-hole 23c, but no female thread is formed inside the through-hole 23c. The contact bolt 41 is held by a retaining portion 41f provided in the vicinity of the upper end not to fall from the through-hole 23c.

The rotating portion 30 has the lower surface 30f supported by the flange portion 41c of the contact bolt 41. Since there is play between the rotating portion 30 and the flange portion 41c, the rotating portion 30 can rotate around the contact bolt 41 as an axis.

The contact bolt 41 has a threaded portion 41a formed below the flange portion 41c. The attaching portion 42a of the tip end arm 42 is attached to this threaded portion 41a. Specifically, the threaded portion 41a of the contact bolt 41 engages with a female threaded portion 42e formed on the tip end arm 42. When the contact bolt 41 rotates, the tip end arm 42 moves up and down due to the screw action. The upper surface of the attaching portion 42a serves as a second seating surface 41d that can abut against the rotating portion 30.

In this configuration, as illustrated in FIG. 12, when the contact arm 18 is at its shortest length (in other words, when the tip end arm 42 is at its top dead center position), the upper surface 30e of the rotating portion 30 abuts against the first seating surface 23d of the first arm 20, and the lower surface 30f of the rotating portion 30 abuts against the second seating surface 41d of the second arm 40. That is, the rotating portion 30 (dial) itself acts as a member that restricts the movement, and the torque of the rotating portion 30 is distributed and received by the two seating surfaces (the first seating surface 23d and the second seating surface 41d). With this configuration, torque can be received over a wide surface without increasing the diameter (contact area) of the rotating portion 30, and excessive rotation of the rotating portion 30 can be suppressed. By suppressing excessive rotation of the rotating portion 30, it is possible to suppress the phenomenon of the screw seizing (the phenomenon in which the screw is tightened and cannot be rotated in the opposite direction).

### Modified Example 7

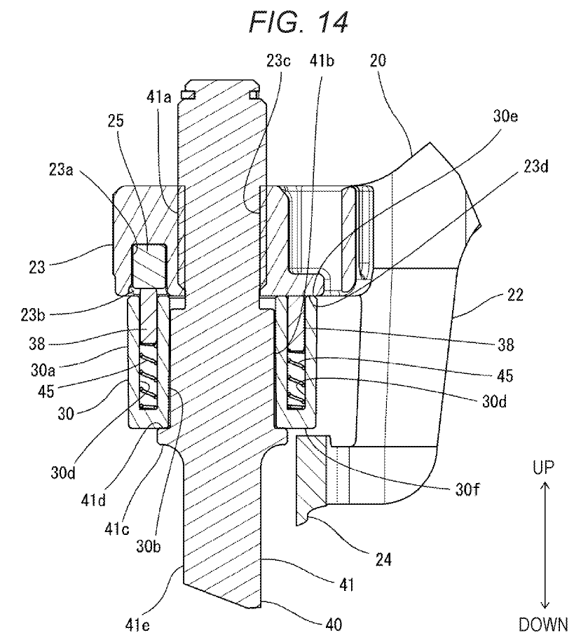

As illustrated in FIG. 14, a rod-shaped first restricting member 38 may be biased in the protruding direction by a biasing member 45 such as a spring. The first restricting member 38 is slidably accommodated inside the holding hole 30d formed in the rotating portion 30. The tip end of the first restricting member 38 is capable of protruding from and retracting into the surface of the rotating portion 30 and is biased in the protruding direction by the biasing member 45. The tip end of the first restricting member 38 protruding from the surface of the rotating portion 30 can enter the accommodation portion 23a formed in the facing portion 23. By the first restricting member 38 entering the accommodation portion 23a, the two engage with each other, and the rotation of the rotating portion 30 is restricted. When the rotating portion 30 rotates, the first restricting member 38 is pushed into the holding hole 30d against the biasing force of the biasing member 45, thereby releasing the restriction on the rotation of the rotating portion 30.

In the present embodiment, the second restricting member 25 is disposed inside the accommodation portion 23a. In this case, at least one of the first restricting member 38 and the second restricting member 25 may be formed of a magnet, and the other may be formed of a magnetic material such as metal. With this configuration, the rotation of the rotating portion 30 can be restricted by magnetic force.

However, in the present modified example, the first restricting member 38 and the second restricting member 25 may be made of other materials, that is, they do not necessarily have to restrict the rotation of the rotating portion 30 by magnetic force. Even without using magnetic force, the rotation of the rotating portion 30 can be restricted by the biasing force of the biasing member 45.

### Modified Example 8

In the above embodiment, the facing portion 23 on which the second restricting member 25 is disposed is provided on the first arm 20, but the second restricting member 25 and the facing portion 23 may be provided in a location other than the first arm 20.

For example, as illustrated in FIG. 15, the second restricting member 25 may be disposed on the facing portion 23 fixed to the body housing 12.

Furthermore, the configurations of the first arm 20 and the second arm 40 are not limited to the above-described embodiment, and can be freely set as long as they fall within the scope of the claims.

For example, in the modified example illustrated in FIG. 15, the first arm 20 is a sheet metal member bent into a substantially L-shape, and is provided at the upper end thereof with the trigger engaging portion 20a that can engage with the contact lever 14a. Furthermore, the connecting portion 22 that comes into contact with the upper end of the second arm 40 is provided at the lower end of the first arm 20. The first arm 20 is pressed against the second arm 40 by a spring 20b, and the connecting portion 22 abuts against the upper end of the second arm 40. This connecting portion 22 is not fixed to the second arm 40. In this manner, the first arm 20 and the second arm 40 may be connected by making them abut against each other in the up-down direction.

In the present example, the contact bolt 41 engages with the first arm 20 at the upper end thereof. The contact bolt 41 may simply be in contact with the first arm 20 or may be coupled thereto. The threaded portion 41a of the contact bolt 41 threadedly engages with a female thread formed on the inner peripheral surface of the attaching portion 42a of the tip end arm 42. Since the contact bolt 41 and the tip end arm 42 are coupled by a screw, when the contact bolt 41 rotates, the tip end arm 42 moves relative to the first arm 20. That is, when the rotating portion 30 is operated and the rotating portion 30 and the contact bolt 41 rotate integrally, the tip end arm 42 advances and retracts up and down.

### Others

The present disclosure is not limited to the above-described embodiments, and various modifications are possible within the scope of the claims. For example, embodiments obtained by appropriately combining the technical means disclosed in different embodiments and modified examples are also included in the technical scope of the present invention.

According to one aspect of the present disclosure, a driving tool for driving a fastener, includes: a nose portion having an injection passage of the fastener; a drive mechanism configured to drive the fastener supplied to the injection passage; a trigger portion configured to actuate the drive mechanism; a movable member that is provided movably to take a first position where an operation of the trigger portion is enabled, and a second position where the operation of the trigger portion is disabled; and a contact arm that is provided slidably with respect to the nose portion and that is configured to move by being pressed against a workpiece. The contact arm includes a first arm engageable with the movable member, a second arm that extends from the first arm in a driving direction and that is configured to abut against the workpiece, and a rotating portion configured to be rotatable. The second arm is configured to be movable relative to the first arm by rotating the rotating portion. Rotation of the rotating portion is restricted by a magnetic force.

According to another aspect of the present disclosure, a driving tool for driving a fastener, includes: a nose portion having an injection passage of the fastener; a drive mechanism configured to drive the fastener supplied to the injection passage; a trigger portion configured to actuate the drive mechanism; and a contact arm that is provided slidably with respect to the nose portion and that is configured to move by being pressed against a workpiece so as to enable an operation of the trigger portion. The contact arm includes a first arm engageable with the trigger portion, a second arm that extends from the first arm in a driving direction and that is configured to abut against the workpiece, and a rotating portion that is configured to be rotatable and that connects the first arm and the second arm. The second arm is configured to be movable relative to the first arm by rotating the rotating portion. Rotation of the rotating portion is restricted by a magnetic force.

According to the present disclosure, since the rotation of the rotating portion is restricted by magnetic force, it is not necessary to use a steel ball as in the related art. Therefore, since small components are not used and it is not necessary to compress a spring for assembly, assemblability during manufacturing is good. Further, strict dimensional control is not required, and stable operational load can be achieved even with rough dimensional control.

What is claimed is:

1. A driving tool for driving a fastener, comprising:
a nose portion having an injection passage of the fastener;
a drive mechanism configured to drive the fastener supplied to the injection passage;
a trigger portion configured to actuate the drive mechanism;
a movable member that is provided movably to take a first position where an operation of the trigger portion is enabled, and a second position where the operation of the trigger portion is disabled; and
a contact arm that is provided slidably with respect to the nose portion and that is configured to move by being pressed against a workpiece, wherein
the contact arm includes a first arm engageable with the movable member, a second arm that extends from the first arm in a driving direction and that is configured to abut against the workpiece, and a rotating portion configured to be rotatable,
the second arm is configured to be movable relative to the first arm by rotating the rotating portion, and
rotation of the rotating portion is restricted by a magnetic force.

2. The driving tool according to claim 1, further comprising:
a first restricting member provided on the rotating portion; and
a second restricting member provided on a facing portion disposed to face the rotating portion, wherein
the first restricting member and the second restricting member are attractable to each other by magnetic force, and
the rotation of the rotating portion is restricted by the first restricting member and the second restricting member facing and attracting each other when the rotating portion rotates to a predetermined position.

3. The driving tool according to claim 2, wherein
the first restricting member and the second restricting member are configured to face and attract each other each time the rotating portion rotates by a predetermined angle.

4. The driving tool according to claim 2, wherein
at least one of the rotating portion or the facing portion includes a guide portion that is configured to movably guide the first restricting member or the second restricting member, and
when the first restricting member and the second restricting member face each other, at least one of the first restricting member or the second restricting member moves along the guide portion and is attracted to another of the first restricting member or the second restricting member.

5. The driving tool according to claim 4, wherein
a movement direction of the first restricting member or the second restricting member is a direction perpendicular to an attraction surface of the first restricting member and the second restricting member.

6. The driving tool according to claim 4, wherein
the first restricting member and the second restricting member are separated from each other when the rotating portion rotates.

7. The driving tool according to claim 4, wherein
the one of the first restricting member or the second restricting member includes a recess portion with which the other of the first restricting member or the second restricting member is engageable.

8. The driving tool according to claim 4, wherein
the first restricting member or the second restricting member is configured to engage with a recess portion formed on the rotating portion or the facing portion.

9. The driving tool according to claim 4, further comprising:
an isolation portion configured to guide the first restricting member and the second restricting member in a detachment direction by converting a direction of rotational movement of the rotating portion and causing the rotational movement to act on the first restricting member or the second restricting member.

10. The driving tool according to claim 9, wherein
the isolation portion is a tapered portion or an R-shaped portion inclined in a rotational direction of the rotating portion.

11. The driving tool according to claim 2, wherein
the first restricting member is a pin inserted into the rotating portion.

12. The driving tool according to claim 2, wherein
the rotating portion is a dial operable from outside.

13. The driving tool according to claim 2, wherein
the first restricting member and the second restricting member are configured to generate a magnetic field in a direction of a rotation axis of the rotating portion.

14. The driving tool according to claim 1, wherein
when the rotating portion is rotated in a direction to shorten the contact arm, the rotating portion is sandwiched between the first arm and the second arm, thereby restricting movement of the contact arm in a shortening direction.

15. The driving tool according to claim 1, wherein
when the rotating portion is rotated, the second arm moves relative to the first arm by a screw action.

16. The driving tool according to claim 15, further comprising:
a contact bolt that connects the first arm and the second arm, wherein
the contact bolt has a male thread, the first arm and the second arm are connected via the male thread, and
the rotating portion and the contact bolt are configured to rotate integrally.

17. The driving tool according to claim 16, wherein
the male thread formed on the contact bolt threadedly engages with a female thread formed in the first arm.

18. The driving tool according to claim 15, wherein
the second arm includes a contact bolt that engages with the first arm, and a tip end arm that is coupled by a screw to the contact bolt,
the rotating portion and the contact bolt are configured to rotate integrally, and
when the contact bolt rotates, the tip end arm moves relative to the first arm.

19. The driving tool according to claim 9, wherein
the isolation portion is provided at the facing portion or the first restricting member.
